(19) United States
(12) Patent Application Publication
(10) Pub. No.: US 2011/0262600 A1
(43) Pub. Date: Oct. 27, 2011

(54) Blended Beverages

(76) Inventor: Shane Robert McGill, Kent (GB)

(21) Appl. No.: 13/132,488

(22) PCT Filed: Dec. 2, 2009
(86) PCT No.: PCT/GB2009/051637

§ 371 Date: Jul. 18, 2011

(30) Foreign Application Priority Data
Dec. 2, 2008 (GB) 0822002.2
Jan. 16, 2009 (GB) 0900710.5

(51) Int. Cl. B65D 85/78; A23G 9/04; B65D 51/32; A23L 2/38

(52) U.S. Cl. 426/112; 426/590; 426/586

(57) ABSTRACT

A frozen or semi-frozen ingredient is pre-packed in a drinks vessel at a packing location. The pre-packed drinks vessel is then transported to a dispensing location remote from said packing location. Liquid is poured into the drinks vessel at said dispensing location and blended with the frozen or semi-frozen ingredient. The drinks vessel defines a chamber in which the frozen or semi-frozen ingredient is packed at the packing location, the chamber having a base and a side wall extending up from the base. The frozen or semi-frozen ingredient is packed in said chamber in such a manner as to define a spacing between said frozen or semi-frozen ingredient and said side wall, into which the liquid ingredient may flow when added at the dispensing location.

The present invention relates to blended beverages of the kind made from two or more ingredients blended together using a high speed impeller. More particularly, but not exclusively, the invention relates to methods for preparing blended beverages and pre- packed containers for use in preparing blended beverages.

Blended beverages are typically made by blending a liquid ingredient with one or more additional ingredients, such as pieces of fruit or ice cream. Traditionally, blended beverages have been prepared using conventional food blenders.

Alternative methods for preparing blended beverages are known from WO2007057671, WO2006126009, WO2005013787, WO2004002281 and WO9921466. Typically, these methods involve placing ingredients to be blended in a container, applying a lid to the container to seal the ingredients within the container. In most cases, the lid has an impeller for blending the ingredients in the container, and the assembly of lid and container can be inverted and placed on a drive unit to cause the impeller to rotate and blend the ingredients together in the container.

In order to provide a chilled blended beverage, it is known to add pieces of ice (whether ice cubes, shaved ice or crushed ice), to the ingredients to be blended. However, there are a number of problems associated with blending pieces of ice, including problems of noise, consistency of blending and potential damage to the blending apparatus. These problems are discussed in WO2008142382, which sets forth an alternative chilled ingredient for use in blended beverages. However, despite being advantageous in many respects, there are limitations associated with the storing of the chilled ingredient set forth in WO2008142382 prior to blending.

It is an object of the invention to provide a method for preparing a chilled blended beverage which overcomes a limitation of the ingredient set forth in WO2008142382.

According to a first aspect of the invention, there is provided a method of preparing a blended beverage, the method including the steps of pre-packing a frozen or semi-frozen ingredient in a container at a packing location, wherein the frozen or semi-frozen ingredient is packed in such a way as to define a void around or adjacent said frozen or semi-frozen ingredient for receiving a liquid ingredient to be blended in the container with the frozen or semi-frozen ingredient; transporting the pre-packed container including the frozen or semi-frozen ingredient to a blending location remote from said packing location; adding a liquid ingredient to said container (preferably at said blending location); and blending said liquid ingredient with said frozen or semi-frozen ingredient in said container at said blending location.

The terms ‘pre-packed’ or ‘pre-packaged’ herein should be understood to mean that the container is charged with an ingredient at a location (e.g. an industrial food packaging plant) which is remote from the intended blending or dispensing location (e.g. a retail outlet or domestic environment). References to “pre-packed” or “pre-packaged” ingredient herein should be construed accordingly.

The frozen or semi-frozen ingredient is preferably a frozen or semi-frozen dessert. The term ‘frozen or semi-frozen dessert’ will be understood to mean a product from the family including ice creams, sorbets, frozen yoghurts, frozen custards, sherbets and other such frozen or semi-frozen confections. It will be understood that frozen pieces of fruit per se do not constitute a frozen dessert within the meaning of this application.

Most preferably, the frozen dessert is of the kind which is produced industrially and stored in deep freezing conditions after production, e.g. at around or below −15° C.

In preferred embodiments, the frozen or semi-frozen ingredient is an industrially produced ice cream or similar dessert-type frozen confection of the kind which is stored at deep freezing temperatures after production, e.g. at around or below −15° C.

In preferred embodiments, the frozen or semi-frozen ingredient is stored in deep freezing temperatures, e.g. around or below −15° C., prior to transportation to the remote blending location.

The frozen or semi-frozen ingredient may be a concentrated product (e.g. including favours, fruit, fat, stabiliser etc), for providing a desired solid content within the beverage after blending.

It is important to note that this aspect of the invention is not intended to cover the pre-packing of ice cubes or other such solid pieces of ice (or the pre-packing of liquids specifically intended to be converted into ice cubes or other such solid pieces of ice). Conventional ice cubes, crushed ice or ice shavings are prone to fusing together during cold storage and so are generally unsuitable for remote packing and shipping, unlike ice creams, sorbets or other such frozen or semi-frozen confections. Moreover, conventional ice cubes, crushed ice or ice shavings are less likely to blend correctly or consistently and are furthermore unsuitable for blending using plastic impeller blades of the kind described in WO2005013787, for example.

Specifically, the frozen or semi-frozen products used as pre-packed ingredients in this aspect of the invention provide an alternative to ice cubes or other conventional forms of ice of the kind added to beverages to provide the desired cold mouth feel of a chilled beverage, such as crushed ice or ice shavings. Unlike ice cubes, crushed ice or ice shavings, frozen or semi-frozen ingredients such as ice creams, sorbets or other such frozen or semi-frozen confections are ideally suited for storage and shipping in deep freezing conditions (e.g. around or below −15° C.), without significant detrimental effect to the structural integrity of the ingredient (whereas ice cubes, crushed ice or ice shavings have a tendency to fuse together). Moreover, the nature of such ingredients lends itself to blending in a drinks vessel, more readily than ice cubes or crushed ice, for example.

Preferably, the pre-packed container is transported to the remote blending location in deep freezing conditions, e.g. around or below −15° C., in order to maintain the structural integrity of the frozen or semi-frozen ingredient, e.g. up until the point of delivery to the blending location.

It should be understood that the frozen or semi-frozen products used as pre-packed ingredients in this aspect of the invention are preferably soft enough to be blended within the container using known blending impellers, at least at the point of blending. For certain embodiments, a tempering cabinet or other storage means may be required at the blending location, for raising the temperature of the pre-packed ingredient, in order to make the frozen or semi-frozen ingredient more suitable for a blending operation. However, the pre-packed ingredient should preferably remain in a frozen or semi-frozen state, e.g. below the latent heat of fusion of the ingredient, at least up until the point of blending, in order to produce the desired ‘frozen’ mouth feel of a chilled beverage.

It will be understood that the method according to this aspect of the invention involves only a partial filing of the container with the frozen or semi-frozen ingredient, in order to leave the void(s) in which a volume of liquid can added to facilitate blending of the ingredient within the container.

In contrast, conventional methods of pre-packing frozen or semi-frozen desserts such as ice cream or sorbet involve a ‘substantial’ filing of the associated container with said frozen or semi-frozen food stuffs. Although conventional pre-packing methods may sometimes result in a cavity being formed in the upper surface of the pre-packed ingredient, and in many cases the upper surface of the pre-packed ingredient may be spaced from the rim or lid of the container, such cavities or spacings are neither intended for, nor suitable for, receiving a volume of liquid to facilitate blending of the pre-packed ingredient within the container, in order to produce a blended beverage.

In order to blend a beverage in a conventional ice-cream container, for example, a proportion of the frozen ingredient would need to be removed at the dispensing location in such a way as to leave a void suitable for facilitating blending of the frozen ingredient with a liquid added to the container. This is wholly distinct from the concept of partially filling a container with a frozen or semi-frozen ingredient at a packing location in such a manner to define in such a way as to define a void around or adjacent the frozen or semi-frozen ingredient, in which a volume of liquid can be used to facilitate blending of the ingredient in the container to create a blended beverage within the container at a remote blending location.

In view of the above, it should be understood that this aspect of the invention is clearly distinct from conventional methods of pre-packing frozen or semi-frozen desserts such as ice creams, sorbets and other such confections.

The pre-packed frozen or semi-frozen ingredient may consist of one or more products. Other ingredients may be included prior to, during or after blending, for example non-frozen ingredients such as fruit pieces, chocolate, confectionary, etc.

The liquid ingredient is preferably water, milk, fruit juice or a combination of ingredients including one or more of water, milk or fruit juice. Other liquids may be preferred, dependent on the desired nature of the blended beverage, e.g. alcoholic liquids for creating blended cocktail beverages.

It should be understood that the choice of liquid (for the purpose of blending) will have an effect on the concentration and temperature of the frozen or semi-frozen product in the container after blending. Preferably, the relative combination of frozen or semi-frozen ingredient and liquid ingredient is designed to produce a “frozen” beverage after blending, wherein the term “frozen” (in this context) means that the frozen or semi frozen ingredient is still below its latent heat of fusion, in order to produce a ‘chilled’ or ‘frozen’ mouth feeling if the beverage is consumed directly after blending.

In preferred embodiments, the frozen or semi-frozen ingredient is charged in said container in such a manner as to define a void extending around, into or through the frozen or semi-frozen ingredient, for receiving the liquid ingredient.

The method preferably involves the step of forming a tower, cone or other upwardly extending formation of said frozen or semi-frozen ingredient within the container at said packing location, but defining at least one void for the purpose of receiving a liquid to facilitate blending of the ingredient in the container.

In a preferred method, the container defines a chamber in which the frozen or semi-frozen ingredient is pre-packed at the packing location, the chamber having a base and a side wall extending up from the base, and wherein the frozen or semi-frozen ingredient is charged in said chamber in such a way as to define a spacing between said frozen or semi-frozen ingredient and said side wall, into which the liquid ingredient may flow when added at the dispensing location.

It has been found that the provision of a spacing between the pre-packed frozen or semi-frozen ingredient and the side wall of the container assists blending of the pre-packed ingredient. During blending, the liquid ingredient is able to flow between the pre-packed ingredient and the side wall. Spinning movement of the liquid helps to dislodge the pre-packed ingredient from its contact with the base or side wall of the container, and helps to draw the pre-packed ingredient towards the active blending zone.

The method preferably involves the step of forming an annulus around the frozen or semi-frozen ingredient, more preferably an annulus which extends around the frozen or semi-frozen ingredient for a significant proportion of the height of the frozen or semi-frozen ingredient, e.g. for at least 50% of the height of the frozen or semi-frozen ingredient. The annulus is preferably continuous about the circumference of the frozen or semi-frozen ingredient.

In an alternative method, the container defines a chamber in which the frozen or semi-frozen ingredient is pre-packed at the packing location, the chamber having a base and a side wall extending up from the base, and wherein the frozen or semi-frozen ingredient is charged in said chamber in such a manner as to define one or more ribs projecting from said side wall. In one embodiment, the container is charged with a single rib. However, in other embodiments, the container may be charged with two, three or more ribs, e.g. at an equidistant spacing from one another.

During blending, the liquid is caused to spin and is driven against the projecting rib. The movement of the liquid acts to dislodge the frozen or semi-frozen ingredient from the side wall and draws the pre-packed ingredient towards the active blending zone.

In a variant of the invention, the frozen or semi-frozen ingredient is packed in a layer at the lower end of the container, so as to define a space above the pre-packed frozen or semi-frozen ingredient for the liquid ingredient. In such variants, it is particularly preferred if the side wall includes a coating adapted to promote release of the frozen or semi-frozen ingredient from the side wall during blending, e.g. under the influence of heat. Such coatings are common in the art of ice cream packing (e.g. in pre-packed ice cream cones) and may be applied to any of the embodiments described herein.

The liquid ingredient may be added before or during blending. In one embodiment, the liquid ingredient is added before the container is loaded into a blending apparatus, e.g. of the kind shown in WO2007057671, WO2006126009, WO2005013787, WO2004002281 or WO9921466. In another embodiment, the liquid ingredient is added by automatic filling of liquid into the container at the blending location (e.g. when the container is located in a blending apparatus of the kind shown in WO2007057671, WO2006126009, WO2005013787, WO2004002281 and WO9921466), before or during blending.

In another variant of the invention, the liquid ingredient is pre-packed in the container at the packing location, together with the frozen or semi-frozen ingredient. The two ingredients are preferably co-extruded in a frozen state, preferably stored in a frozen state and may be tempered prior to blending to return the liquid ingredient from its frozen state to a liquid state, whilst leaving the frozen or semi-frozen ingredient in its frozen or semi-frozen state.

The blending lid may be fitted to the container at the packing location, in order to seal the contents in the container. Where the liquid is added at the blending location, this may be via a port in the lid or by removal of the lid prior to addition of the liquid.

Additional liquid ingredient may be added after blending, e.g. via a port in the lid or by removal of the lid after blending.

The term ‘blending’ is intended to mean that the ingredients in the container are agitated under the influence of a rotating device, causing the liquid to spin and the ingredients to be mixed together within the container. The term blended beverage should be construed accordingly. The most preferred embodiments will involve the use of a high speed impeller having blades intended to breakdown the ingredients.

The method preferably involves the use of a blending lid having a rotatable impeller which is applied to an open end of the container at the dispensing location. The assembled combination of container and blending lid is preferably inverted for the purpose of the high speed blending operation. Examples of suitable container and blending lid combinations are shown in WO2007057671, WO2006126009, WO2005013787, WO2004002281 and WO9921466, the contents of which are incorporated herein by reference.

In preferred embodiments, the pre-packaged ingredient extends upwards within the container to a height which corresponds generally to the normal working position of the impeller when assembled with the container.

In preferred embodiments, the blending lid is applied to the container, the combination of lid and container is inverted, and the impeller is activated to blend the pre-packed ingredient and the liquid ingredient within the container. The activation of the impeller is preferably subject to interruptions, most preferably during the initial stages of blending, e.g. to allow the ingredients to settle within the container between periods of impeller rotation.

The inverted combination of blending lid and container is preferably located on a blending drive unit configured to drive the impeller on the blending lid. The drive unit is preferably mounted in a housing into which the combination of lid and container is placed for the purpose of the blending operation.

After blending, the beverage may be consumed directly from the container or the beverage may be transferred to a separate vessel for consumption. If the beverage is consumed from the container in which it was blended, this may be via the blending lid (e.g. through a drinking aperture in the lid), or by removing the blending lid and drinking from the container or through a further drinking lid applied to the open end of the container.

The container may be heated during the blending operation. This may involve the use of microwave heating, hot air blown against or around the container, or a heated plunger arranged to engage the upturned end of the container or to act as a cowl around at least a portion of the sides of the container when inverted on the drive unit.

In preferred methods, the container is a drinks vessel (e.g. a cup, can or beaker) from which the blended beverage can be directly consumed. More preferably, the container is a single-use, disposable item, e.g. of paper, cardboard, or thin-walled plastic construction (or a combination of such materials).

According to another aspect of the invention, there is provided a pre-packed container for use in the preparation of a blended beverage, the pre-packed container comprising a chamber having a base and a side wall extending up from the base, and a partial filing of frozen or semi-frozen ingredient within the chamber, for blending with a liquid ingredient at a location remote from the packing location.

The frozen or semi-frozen ingredient is preferably of the kind set forth with the respect to the first aspect of the invention, e.g. a frozen dessert in the form of an ice cream, sorbet or other such frozen or semi-frozen confection, which is preferably of the kind stored at deep freezing temperatures (e.g. at around or below −15° C.) prior to dispensing. As such, this aspect of the invention is not intended to cover the pre-packing of ice cubes or other such solid pieces of ice (or the pre-packing of liquids specifically intended to be converted into ice cubes or other such solid pieces of ice), for the reasons discussed above. Specifically, the frozen or semi-frozen products used as pre-packed ingredients in this aspect of the invention provide an alternative to ice cubes or other conventional forms of ice of the kind added to beverages to provide the desired cold mouth feel of a chilled beverage, such as crushed ice or ice shavings.

The pre-packed frozen or semi-frozen ingredient may consist of one or more products. The frozen or semi-frozen ingredient may be a concentrated product (e.g. including favours, fruit, fat, stabiliser etc), for providing a desired solid content within the beverage after blending.

The frozen or semi-frozen ingredient is preferably packed in such a way as to define at least one void for receiving a liquid ingredient to be blended in the container with the frozen or semi-frozen ingredient.

The arrangement of the frozen or semi-frozen ingredient in the container is preferably the same as any one of the embodiments set forth with respect to the first aspect of the invention, defining at least one void for the purpose of receiving a liquid to facilitate blending of the ingredient in the container.

The liquid ingredient may be pre-packed in the container at the packing location, together with the frozen or semi-frozen ingredient. The two ingredients are preferably co-extruded in a frozen state, preferably stored in a frozen state and may be tempered prior to blending to return the liquid ingredient from its frozen state to a liquid state, whilst leaving the frozen or semi-frozen ingredient in its frozen or semi-frozen state.

The pre-packed container may include a blending lid fitted to the container at the packing location, in order to seal the contents in the container. The container and blending lid are preferably the same as any one of the embodiments set forth with respect to the first aspect of the invention.

The pre-packed container is preferably intended to be stored and transported in freezing conditions, e.g. at around or below −15° C., in order to maintain the structural integrity of the frozen or semi-frozen ingredient, e.g. up until the point of delivery to a blending location.

According to another aspect of the invention, there is provided a blended beverage prepared in a container at a blending location by blending a combination of frozen or semi-frozen ingredient pre-packed in the container at a packing location remote from the blending location with a liquid ingredient added to the container at the packing location or at the blending location.

According to another aspect of the invention, there is provided a method for preparing a blended beverage, the method including the steps of charging a drinks vessel with ice cream product from a soft serve dispensing apparatus; adding a liquid ingredient to said container at said dispensing location; and blending said liquid ingredient with said ice cream product in said container at said dispensing location.

Other aspects and features of the invention will be readily apparent from the following description, made by way of example only, with reference to the accompanying Figures, in which:

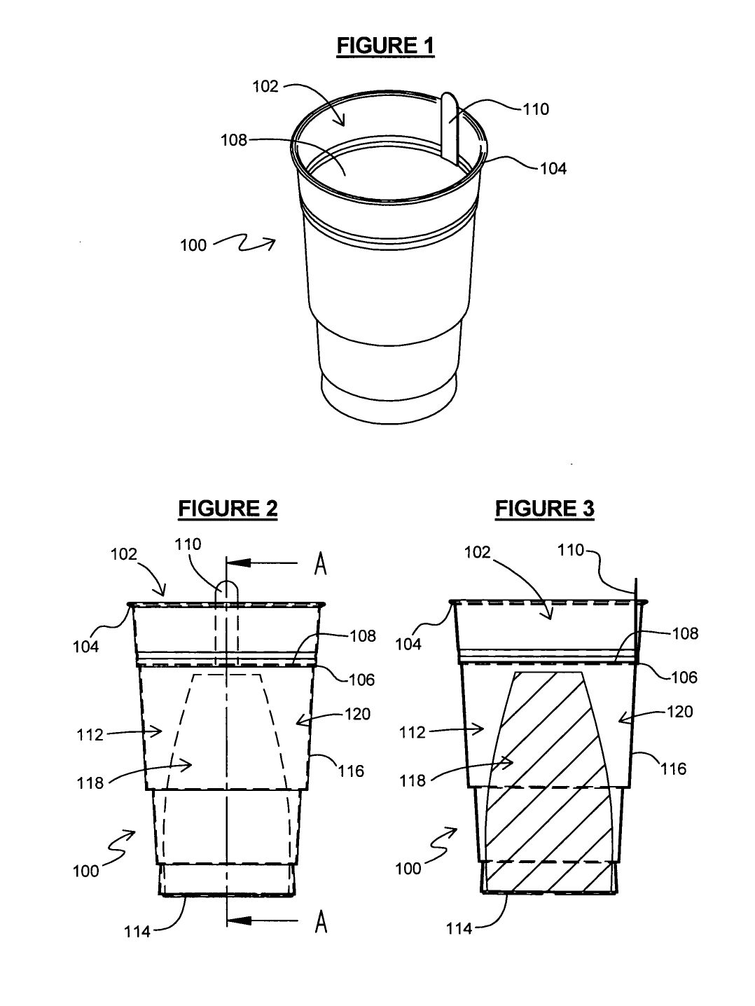

FIG. 1 is a schematic perspective view of a pre-packed container in accordance with a preferred embodiment of the invention;

FIG. 2 is a front view of the container is FIG. 1, showing hidden features in dotted outline;

FIG. 3 is a cross-sectional view of the container in FIG. 2, taken along line A-A;

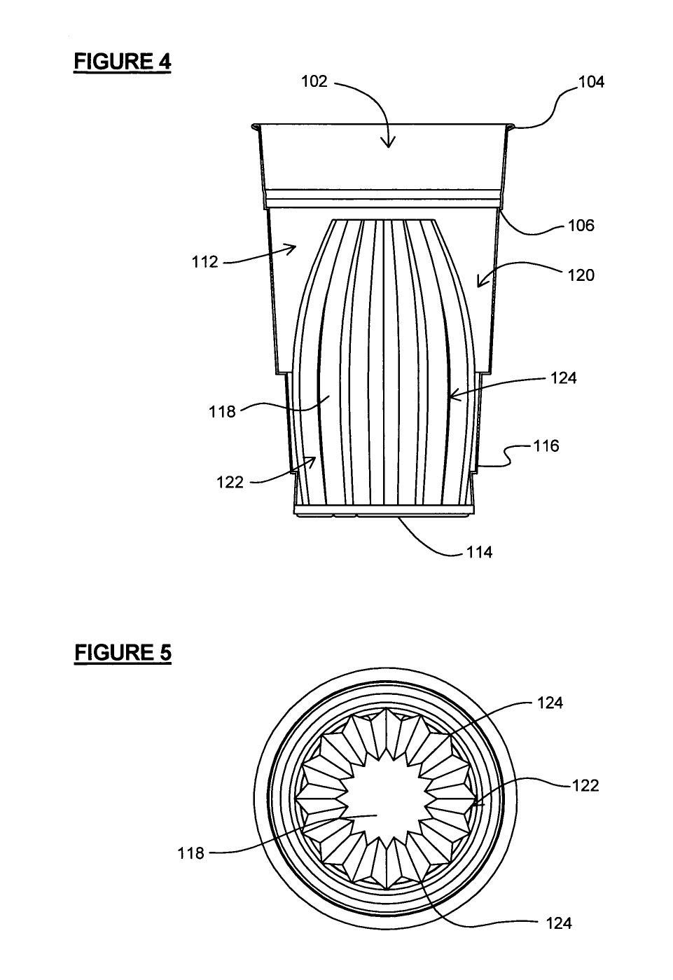

FIG. 4 is similar to FIG. 2 but shows a first modified configuration of pre-packed ingredient within the container;

FIG. 5 is a plan view of the container in FIG. 4;

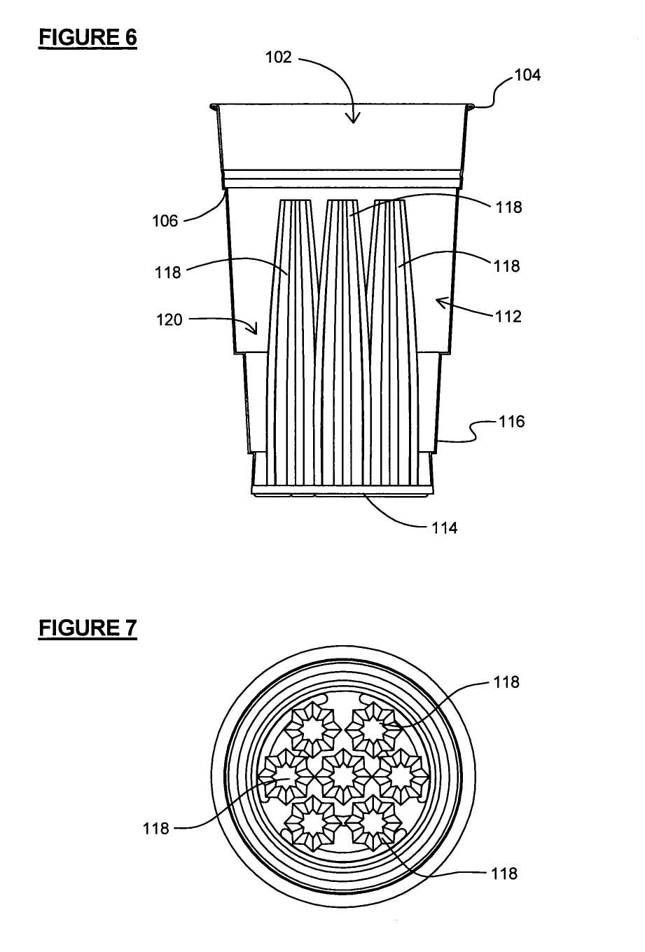

FIG. 6 is similar to FIG. 2 but shows a second modified configuration of pre-packed ingredient within the container;

FIG. 7 is a plan view of the container in FIG. 6;

FIG. 8 is similar to FIG. 2 but shows a third modified configuration of pre-packed ingredient within the container;

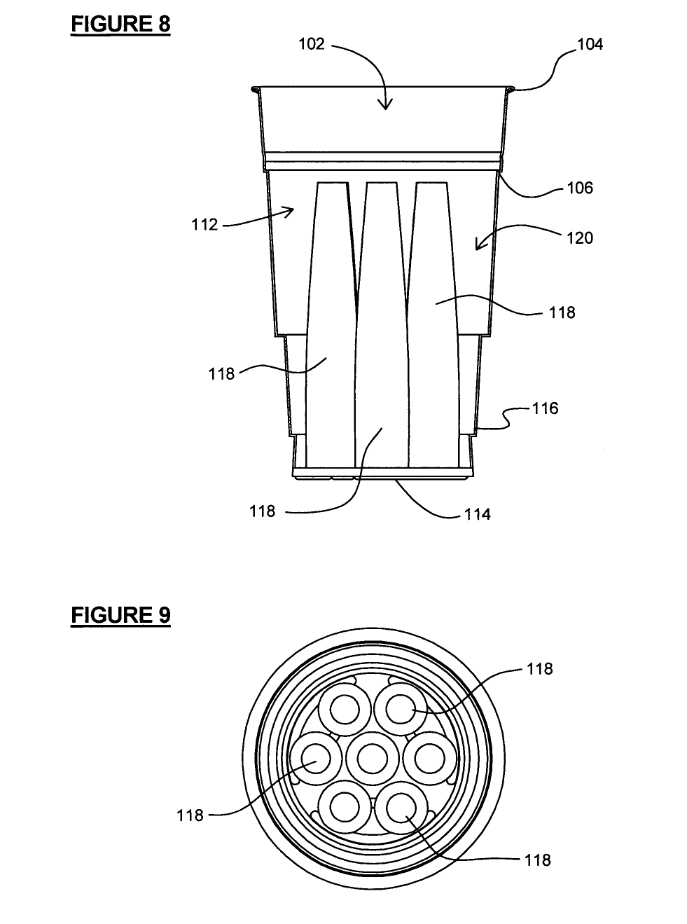

FIG. 9 is a plan view of the container in FIG. 8;

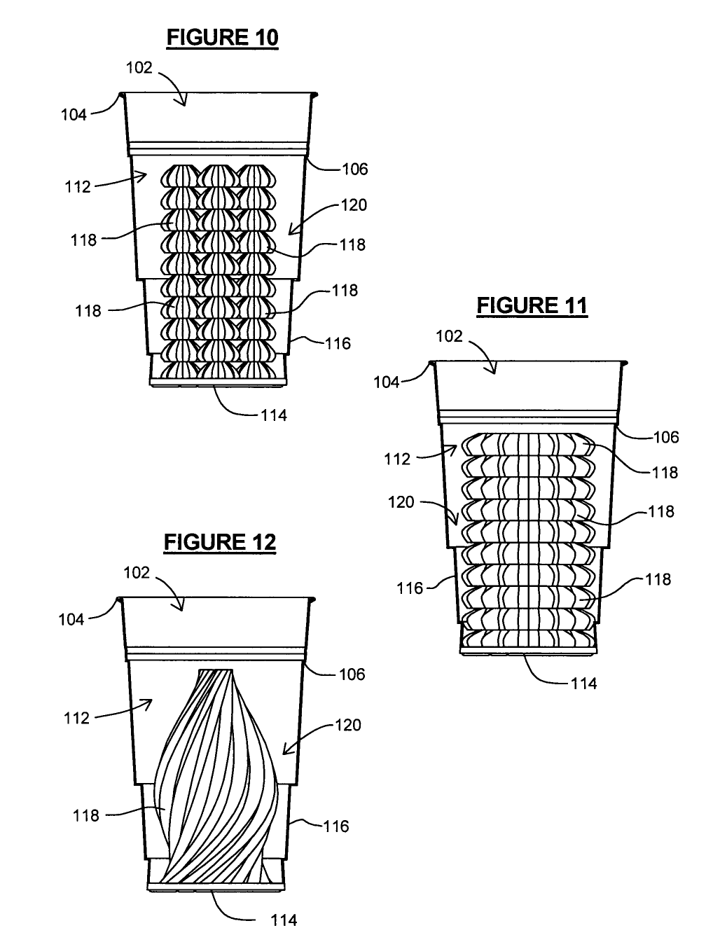

FIG. 10 is similar to FIG. 2 but shows a fourth modified configuration of pre-packed ingredient within the container;

FIG. 11 is similar to FIG. 2 but shows a fifth modified configuration of pre-packed ingredient within the container;

FIG. 12 is similar to FIG. 2 but shows a sixth modified configuration of pre- packed ingredient within the container;

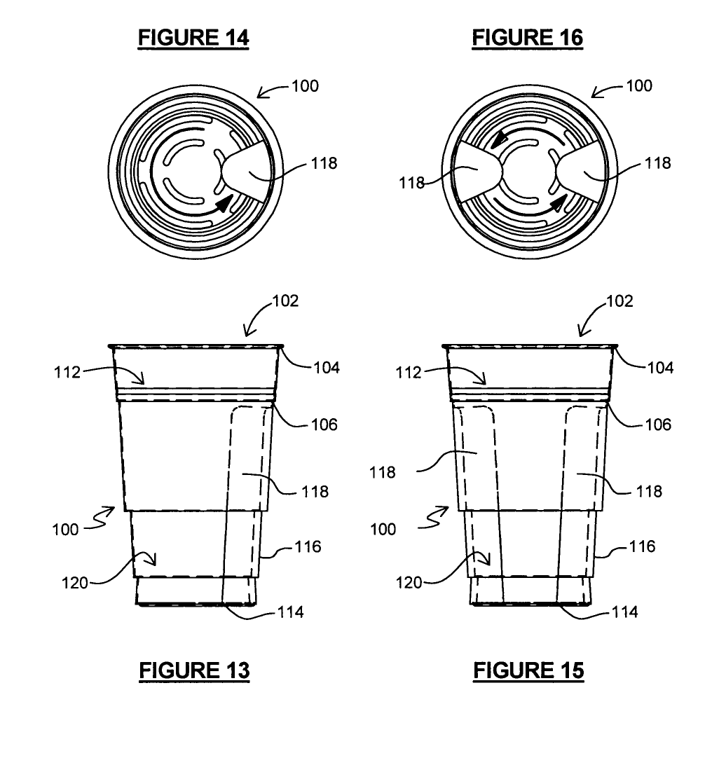

FIG. 13 is a schematic side view of a drinks vessel incorporating a rib of frozen or semi-frozen ingredient;

FIG. 14 is a plan view of the drinks vessel in FIG. 13;

FIG. 15 is similar to FIG. 13, showing a drinks vessel incorporating opposing ribs of frozen or semi-frozen ingredient;

FIG. 16 is a plan view of the drinks vessel in FIG. 15;

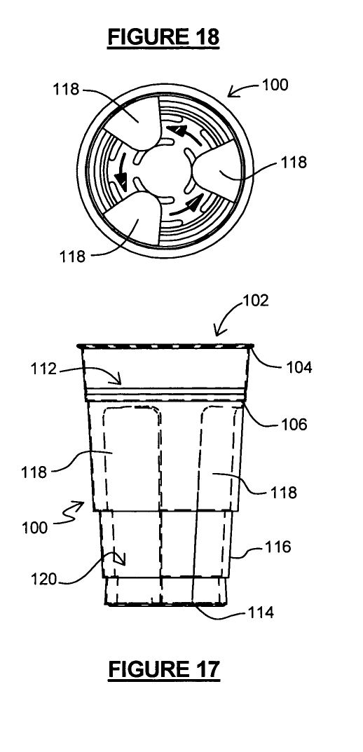

FIG. 17 is similar to FIG. 13, showing a drinks vessel incorporating three ribs of frozen or semi-frozen ingredient; and

FIG. 18 is a plan view of the drinks vessel in FIG. 17.

Referring firstly to FIGS. 1 to 3, a container in the form of a nestable cup- or beaker-type drinks vessel is indicated generally at 100. The drinks vessel 100 may be made of plastic, paper or cardboard material (or a combination of such materials) and is generally of the form described and illustrated in WO2007057671. In particular, the drinks vessel 100 includes an open upper end 102 defining a circumferential rim 104, over which a blending lid having a rotatable impeller (not shown) is intended to be fitted, for the purpose of blending ingredients within the container in order to produce a blended beverage. Examples of suitable blending lids are described and illustrated in WO2005013787, which are typically intended to be disposed of after a single beverage dispensing operation. However, the blending lid may be re-usable, e.g. of the kind described and illustrated in WO2006126009.

The drinks vessel 100 includes an internal shoulder 106 onto which a removable insert 108 can be seated (and preferably removably secured, e.g. via an adhesive or heat weld), for the purpose of sealing ingredients within the drinks vessel 100. The insert 108 includes a tab 110 which extends from the drinks vessel 100, once positioned on the shoulder 106, by means of which the insert 108 can be removed (e.g. by pulling on the tab 110), when it is desired to access the pre-packed ingredients within the drinks vessel 100. In other embodiments, it may be preferable to provide a sealed closure at the uppermost end of the container 100, e.g. affixed to the rim 104. This may be in the form of a heat-sealed cover/diaphragm, or a snap-on lid (which may be removed for the purpose of a blending operation and re-fitted or replaced with another snap-on lid after blending).

It will be understood that the drinks vessel 110 defines a chamber 112 having a base 114 and a circumferential side wall 116 extending up from the base 114. As shown in FIGS. 2 and 3, an ingredient 118 for use in preparing a blended beverage in the drinks vessel 100 is arranged in the chamber 112, upstanding from said base 114. The ingredient 118 defines an upwardly extending tower- or obelisk-type formation in the drinks vessel 100, which extends to a position just below the level of the shoulder 106. More particularly, the ingredient 118 is arranged in the chamber 112 in such a manner as to define an annular spacing 120 between the side wall 116 and the ingredient 118.

In this embodiment, the ingredient 118 is generally circular in plan view, and is of generally tapered construction so as to decrease in diameter from the base 114 upwards.

The ingredient 118 is preferably charged onto the base 114 of the chamber 112 by extrusion.

The height of the ingredient within the chamber 112 corresponds generally with the depth to which the impeller on a preferred blending lid would extend within the drinks vessel 100, when assembled over the open end 102 of the drinks vessel 100.

The pre-packed ingredient 118 is preferably a frozen or semi-frozen dessert-type ingredient, such as an ice cream, sorbet or similar frozen or semi-frozen confection. most preferably of the kind stored at deep freezing temperatures (e.g. at around or below minus 15° C.) prior to dispensing. The frozen or semi-frozen ingredient 118 provides an alternative to ice cubes or other conventional forms of ice commonly used to provide a cold mouth feel in a chilled beverage. Unlike ice cubes, crushed ice or ice shavings, the frozen or semi-frozen ingredient is ideally suited for storage and shipping in freezing conditions, without significant detrimental effect to its structural integrity (whereas ice cubes, crushed ice or ice shavings have a tendency to fuse together). Moreover, the nature of the ingredient lends itself to blending in the drinks vessel, more readily than ice cubes or crushed ice.

In preferred embodiments, the frozen or semi-frozen ingredient is of aerated form (e.g. aerated during its manufacture, before filling into a container. The level of aeration may be adjusted to suit the desired specification of the final blended product.

The pre-packed drinks vessel 100 is intended to form part of a method for preparing a blended beverage, in which the frozen or semi-frozen ingredient 118 is pre-packed in the drinks vessel 100 at a packing location. The pre-packed drinks vessel 100 is then transported to a dispensing location remote from said packing location.

The term ‘pre-packed’ or ‘pre-packaged’ herein should be understood to mean that the container is charged with ingredient and sealed at a location (e.g. an industrial food packaging plant), which is remote from the intended dispensing or blending location (e.g. a retail outlet or domestic environment). References to “pre-packed” or “pre-packaged” ingredient herein should be construed accordingly.

The pre-packed drinks vessel 100 is preferably stored and transported in freezing conditions, in order to maintain the structural integrity of the frozen or semi-frozen ingredient, e.g. up until the point of blending.

At the dispensing location, access is gained to the pre-packed ingredient 118 by removing the insert 108 (e.g. via pulling on the tab 110). A liquid ingredient (not shown) such as water, milk or fruit juice can then be poured into the drinks vessel 100, onto the pre-packed ingredient 118. It will be understood that the liquid ingredient is free to flow into the spacing 120 between the pre-packed ingredient 118 and the side wall 116.

A blending lid of the kind referred to above, i.e. configured to fit over the open end 102 of drinks vessel 100 to seal the beverage ingredients in the drinks vessel 100 and carrying an impeller for blending the beverage ingredients in the drinks vessel 100, is then applied to the drinks vessel 100 for the purpose of blending the pre-packed ingredient 118 with the liquid ingredient.

Other ingredients may be added (e.g. at the blending location) prior to, during or after blending, for example fruit pieces, chocolate, confectionary etc.

Before or during blending, a whipping agent may be added to the container (e.g. at the packing location or blending location). The whipping agent will be intended to take effect during the blending process, to add air to the final beverage and thus produce a desired volume or blended product in the container. Without such whipping agent, it is possible that a proportion of any air in the frozen or semi-frozen ingredient may lost during the blending process and thus only a partially filled container of the blended product will result.

After a suitable period of blending, the blended ingredients form a chilled blended beverage which may be directly consumed from the drinks vessel 100. e.g. by drinking from the rim 104 of the drinks vessel 100 or using a straw (not shown) after removal of the blending lid. Of course, the blending lid may include an aperture through which the beverage may be poured, or through which a straw may be inserted, to consume the beverage. A separate drinking lid may be applied after removal of the blending lid.

In preferred methods, the blending lid is applied to the drinks vessel, the combination of lid and drinks vessel is inverted, and then located on a blending drive unit configured to drive the impeller. The drive unit may be mounted in a housing into which the combination of lid and container can be placed for the purpose of the blending operation.

Activation of the impeller is preferably subject to interruptions, to allow the ingredients to settle within the container after a predetermined period of impeller rotation, e.g. a 5 second pause in rotation of the impeller after each 10 second period of rotation, at least during the initial phase of blending.

It has been found that the provision of a spacing 120 between the pre-packed ingredient 118 and the side wall 116 of the drinks vessel 100 (into which the liquid ingredient may flow) assists blending of the pre-packed ingredient 118. The action of the impeller creates a ‘vortex’ or spinning of the liquid ingredient within the vessel 100, and the liquid is able to flow around the pre-packed ingredient. The movement of the liquid serves to draw the pre-packed ingredient towards the active blending zone of the impeller, dislodging the ingredient from the base or side wall, and so overcomes the disadvantage of surface adhesion between the pre-packed ingredient 118 and the side wall 116 that would otherwise exist if the same ingredient was simply pre-packed in the chamber in a continuous layer (without any clear voids or spacing for the flow of a liquid) in the bottom of the container, e.g. as shown in FIG. 8 of WO9921466.

The drinks vessel may be heated during the blending operation, to further assist movement and/or break down of the pre-packed ingredient during rotation of the impeller. This may involve the use of microwave heating, hot air blown against or around the drinks vessel, or a heated plunger or cowl arranged to engage the end and/or sides of the drinks vessel when inverted on the drive unit (e.g. for the purpose of clamping the container during blending).

Whilst FIGS. 2 and 3 show a generally continuous annulus around the pre-packed ingredient 118, a lower part of the pre-packed ingredient 118 may be in circumferential contact with the side wall 116, e.g. as shown in FIG. 4. The pre-packed ingredient 118 in FIG. 4 is in the form of a generally star-shaped extrusion in plan view (see FIG. 5), such that an array of generally vertical channels 122 are formed between the points 124 of the star shape, into which the liquid ingredient may flow, prior to blending. Although the points 124 are in contact with the side wall 116, the annulus is otherwise substantially continuous.

Other configurations of pre-packed ingredient 118 are envisaged, in each case defining at least one void or spacing for receiving a liquid ingredient for the purpose of facilitating blending within the container.

FIGS. 6 and 7 show an embodiment which includes multiple star shaped formations upstanding from the base 114 of the chamber 112, whereas FIGS. 8 and 9 show an embodiment which includes multiple circular shaped formations upstanding from the base 114. FIG. 10 shows layers of multiple rosette-type extrusions of conventional form arranged on the base 114, whereas FIG. 11 shows layers of single rosette-type extrusions of conventional form arranged on the base 114. FIG. 12 shows a conventional twisted star-shaped ice-cream cone type formation upstanding from the base 114. In each case, a spacing is provided around at least an upper portion of the pre-packed ingredient, into which the liquid ingredient may flow during operation of the impeller on a blending lid, once the lid has been fitted over the end of the cup and the assembly has been inverted and placed on a drive unit for the impeller.

Alternative embodiments are shown in FIGS. 13 to 18, wherein a drinks vessel 100 is provided with one or more towers of frozen or semi-frozen ingredient 118 which each define a rib projecting from the side wall 116 of the vessel 100. The chamber 112 includes a void 120 into which the liquid ingredient may be charged, e.g. through the open end 112.

In FIGS. 13 and 14, the vessel 100 is charged with a single rib, in FIGS. 15 and 16 the vessel 100 is charged with two opposing ribs, and in FIGS. 17 and 18 the vessel 100 is provided with three ribs arranged at an equidistant spacing from one another.

During blending, the liquid ingredient is driven against the projecting rib (e.g. As indicated by the arrows in FIGS. 14, 16 and 18). The movement of the liquid acts to dislodge the frozen or semi-frozen ingredient 118 from the side wall 116, and to draw the pre-packed ingredient down within the inverted container towards the active blending zone of the impeller.

In a variant of the invention, the pre-packed ingredient forms a continuous layer at the lower end of the drinks vessel, so as to define a space above the pre-packed ingredient for the liquid ingredient. In such variants, it is preferred if the side wall includes a coating adapted to promote release of the pre-packed ingredient from the side wall during blending, e.g. under the influence of heat, in order to provide a spacing or void for the blending liquid.

The charging method may include a mechanism configured for producing a ‘spaghetti’ type ice cream configuration within the container (e.g. commonly found in conventional ice cream parlours).

The invention provides for the pre-packing of a “cold” medium (other than conventional ice cubes, crushed ice or ice shavings) at a location remote from the blending location, and allows the pre-packed cold medium to be shipped and stored under existing conventional frozen conditions and temperatures, and then blended with a liquid ingredient within the container.

The liquid ingredient may be added before or during blending. In one embodiment, the liquid ingredient is added before the container is loaded into a blending apparatus. In another embodiment, the liquid ingredient is added by automatic filling of liquid into the container at the blending location (e.g. when the container is located in a blending apparatus), before or during blending.

In a variant of the invention, the liquid ingredient is pre-packed in the drinks vessel at the packing location, together with the frozen or semi-frozen ingredient. The two ingredients are preferably co-extruded in a frozen state, preferably stored in a frozen state and may be tempered prior to blending to return the liquid ingredient from its frozen state to a liquid state, whilst leaving the frozen or semi-frozen ingredient in its frozen or semi-frozen state. Hence, the liquid ingredient preferably has a lower freezing point than the other ingredient.

Additional liquid or solid ingredient may be added prior to, during or after blending.

In view of the above, it will be understood that the invention affords a blended beverage prepared in a drinks vessel at a blending location by blending a combination of frozen or semi-frozen ingredient pre-packed in the drinks vessel at a packing location remote from the blending location with a liquid ingredient added to the drinks vessel at the packing location or at the blending location.

The product of the methods described herein may be referred to as a “frozen” beverage.

The general process for producing the frozen or semi-frozen product and for charging the containers with said frozen or semi-frozen product is preferably the same or similar to conventional processes used for producing and charging containers with ice cream, sorbet or other such frozen or semi-frozen confections, albeit modified to ensure that the container is includes the required void(s) for the liquid ingredient.

It should be understood that the frozen products used in the methods described above must be soft enough to blend within the container using known blending mechanisms (at least at the point of blending). For certain embodiments, a tempering cabinet or other storage means for raising the temperature of the pre-packed ingredient may be required, in order to make the frozen or semi-frozen ingredient more suitable for a blending operation. However, it is preferred that the pre-packed ingredient remains in a frozen or semi-frozen state or below its latent heat of fusion, at least up until the point of blending, in order to produce the desired cold mouth feel to the consumer of the beverage after blending.

The frozen or semi-frozen product filled into the container can be of a neutral flavour, or a base flavour to which additional flavour(s) can be added prior to, during or after blending. In certain embodiments, additional flavour(s) is added during the filling process of the container prior to sealing of product within the container at the packing location. This may be achieved using a conventional ‘sauce’ injector of the kind commonly used in ice cream dairies. Alternatively, a separate liquid or powder applicator/filler may be used, to charge the additional flavour(s) during the filling procedure, most preferably at a separate filling station.

The use of standard single flavour of frozen or semi-frozen ingredient eliminates the requirement (at the packing location) of multiple base flavour mixes to convert into frozen or semi-frozen product, thereby reducing the required number of flavour tanks etc. A flavoured ripple may be added to the base ingredient at the point of filling, e.g. using a conventional ripple feeder.

In preferred embodiments, the pre-packed frozen or semi-frozen ingredient may have or be pre-packed with an additional ingredient having an alcoholic content, for producing a ‘frozen’ cocktail.

For reducing the likelihood of the pre-packed frozen or semi-frozen ingredient sticking to the inside walls/base of the container, an atomised spray of low temperature food quality product can be applied on the filling machine prior to product filling. This spray may comprise or incorporate a lubricant that remains liquid at freezer temperatures or has a low shear characteristic that gives easy “breakaway” from the walls and base once blending commences. Such sprays are common in the ice cream industry.

According to different method of the invention, a blended beverage may be prepared by charging a drinks vessel (e.g. of the kinds referred to already herein) with ice cream product from a soft serve dispensing apparatus (e.g. of known bulk or single portion configuration), adding a liquid ingredient (e.g. of the kinds referred to already herein) to the drinks vessel at the dispensing location, and then blending the liquid ingredient with the ice cream product in said drinks vessel (e.g. using a blending lid or other blending or mixing device). The blended beverage may then be consumed from the drinks vessel.

It should be noted that ‘soft serve’ ice cream is typically dispensed at −4° C. and is unsuitable for packing and storing in deep freezing conditions (e.g. at around or below −15° C.). Hence, this ‘soft serve’ method does not relate the concept of pre-packing frozen or semi-frozen ingredient, as described above. Nevertheless, it provides a novel method of preparing a blended beverage. As with the ‘pre-packed’ methods described above, the container is only partially filled with the ice cream, so as to leave at least one void for the liquid ingredient.

Variant methods (whether ‘pre-packed’ or ‘soft serve’) may use a bulk blending vessel (e.g. a conventional blending jug) rather than a drinks vessel, whereby the blended beverage is poured from the bulk vessel in to a separate drinks vessel for consumption.

In some embodiments, it may be preferred for the blending operation to be carried out using conventional spindle type blenders introduced into the container at the blending location.

In other embodiments, a rotatable impeller may be located in the base of the container, above which the ‘frozen’ ingredient is charged. In such embodiments, the charged configuration of the ‘frozen’ ingredient will preferably be designed to allow the impellor to instigate the blending operation and to allow a free movement of liquid into one or more voids for the purpose blending the ‘frozen’ ingredient within the container.

The blending lids referred to herein are preferably of the kind having blending means sealingly located in an aperture in the lid, the blending means including an impeller arranged on the underside of the lid and drive means on the opposite side of the lid, the drive means being configured for connection to a drive member separate from the container and the lid, for rotating the impeller and blending product within the container.

Although the blending lids referred to in this application (e.g. of the kind described and illustrated in WO2007057671, WO2006126009, WO2005013787 and WO9921466) have an impellor which is arranged to be coaxial with the central axis of the containers to which they are intended to be fitted, it may be preferred for the blending axis to be offset from the central axis of the container, for providing additional agitation within the vortex, to improve blending efficiency.

1. A method for preparing a blended beverage, the method including the steps of pre-packing a frozen or semi-frozen dessert in a container at a packing location, wherein the frozen or semi-frozen dessert is packed in such a way as to define one or more voids for receiving a liquid ingredient to be blended with the frozen or semi-frozen dessert; transporting the pre-packed container to a dispensing location remote from said packing location; and blending a liquid ingredient with said frozen or semi-frozen dessert in said container at said dispensing location.

2. A method according to claim 1 wherein the frozen or semi-frozen dessert is in the form of an ice cream, sorbet or other such frozen or semi-frozen confection.

3. A method according to claim 2 wherein the frozen or semi-frozen dessert is produced industrially and is stored in the container at a temperature of around or below −15° C. prior to delivery to the blending location.

4. A method according to claim 1 wherein the frozen or semi-frozen dessert is charged into the container at the packing location in such a manner as to define a void extending around, into or through the frozen or semi-frozen dessert, for the liquid ingredient.

5. A method according to claim 4 wherein the container includes a base and the frozen or semi-frozen dessert is charged onto said base.

6. A method according to claim 4 wherein the method involves the step of forming at least one tower, cone or other upwardly extending formation of said frozen or semi-frozen dessert within the container at said packing location.

7. A method according to claim 1 wherein the container defines a chamber in which the frozen or semi-frozen ingredient is pre-packed at the packing location, the chamber having a base and a side wall extending up from the base, and wherein the frozen or semi-frozen ingredient is charged in said chamber in such a way as to define a spacing between said frozen or semi-frozen ingredient and said side wall, into which the liquid ingredient may flow.

8. A method according to claim 7 wherein the method involves the step of forming an annulus around the frozen or semi-frozen ingredient.

9. A method according to claim 1 wherein the container defines a chamber in which the frozen or semi-frozen ingredient is pre-packed at the packing location, the chamber having a base and a side wall extending up from the base, and wherein the frozen or semi-frozen ingredient is charged in said chamber in such a manner as to define one or more ribs projecting from said side wall.

10. A method according to claim 1 wherein the container is a drinks vessel from which the blended beverage can be directly consumed.

11. A method according to claim 1 wherein the method involves the use of a blending lid having a rotatable impeller, which is applied to an open end of the container at either the packing location or the blending location, for blending product within the container.

12. A method according to claim 1 wherein the liquid ingredient is added before and/or during blending.

13. A method according to claim 1 wherein the liquid ingredient is added by automatic filling when the container is loaded into a blending apparatus, before or during blending.

14. A method according to claim 1 wherein the liquid ingredient is pre-packed in the container at the packing location.

15. A method according to claim 14 wherein the frozen or semi-frozen dessert is co-extruded with the liquid ingredient in a frozen state, stored in a frozen state and then tempered prior to blending to return the liquid ingredient from its frozen state to a liquid state.

16. A pre-packed container for use in the preparation of a blended beverage, the pre-packed container comprising a chamber having a base and a side wall extending up from the base, pre-packed with a partial filing of frozen or semi-frozen dessert within the chamber for blending with a liquid ingredient.

17. A pre-packed container according to claim 16 wherein the partial filling of frozen or semi-frozen dessert define a void extending around, into or through the frozen or semi-frozen dessert, for receiving a liquid ingredient.

18. A pre-packed container according to claim 17 wherein the frozen or semi-frozen dessert defines a tower, cone or other upwardly extending formation of said frozen or semi-frozen ingredient within the chamber.

19. A pre-packed container according to claim 17 wherein the frozen or semi-frozen dessert is arranged in said chamber in such a manner as to define a spacing between said frozen or semi-frozen dessert and said side wall, wherein the spacing is intended for receiving a liquid ingredient for the purpose of a blending operation.

20. A pre-packed container according to claim 17 wherein the frozen or semi-frozen dessert is arranged in said chamber in such a manner as to define one or more ribs projecting from said side wall.

21. A pre-packed container according to claim 16 wherein the frozen or semi-frozen dessert is in the form of ice cream, sorbet or other such frozen or semi-frozen confection.

22. A pre-packed container according to claim 16 wherein the container is a drinks vessel from which the blended beverage can be directly consumed.

23. A pre-packed container according to claim 16 wherein the container includes a pre-packed volume of frozen liquid within said chamber, separate from the frozen or semi-frozen dessert.

24. A prep-packed container according to claim 16 including a blending lid having blending means sealingly located in an aperture in the lid, the blending means including an impeller arranged on the underside of the lid and drive means on the opposite side of the lid, the drive means being configured for connection to a drive member separate from the container and the lid, for rotating the impeller and blending product within the container.

25. A pre-packed container according to claim 24 wherein the blending lid is united with the container at the packing location.

26. A blended beverage prepared in a container at a blending location by blending a combination of frozen or semi-frozen dessert pre-packed in the container at a packing location remote from the blending location with a liquid ingredient added to the container at the packing location or at the blending location.

27. (canceled)
